(19) United States
(12) Patent Application Publication
(10) Pub. No.: US 2024/0301209 A1
(43) Pub. Date: Sep. 12, 2024

(54) Mixtures and methods of producing paving products using same

(71) Applicant: Gary Wilson, Calgary (CA)

(72) Inventor: Gary Wilson, Calgary (CA)

(21) Appl. No.: 18/120,327

(22) Filed: Mar. 10, 2023

(51) Int. Cl. C08L 95/00; E01C 5/12; E01C 19/10

(52) U.S. Cl. CPC C08L 95/00; E01C 5/12; E01C 19/1004; C08L 2207/22; C08L 2555/22; C08L 2555/34; C08L 2555/52

(57) ABSTRACT

A mixture formed from desired proportions of recycled asphalt shingle and recycled asphalt pavement is disclosed. The methods of molding the mixture into paving blocks, which exhibit properties of high compressive strength and low water absorption, are described. The paving blocks may be used to construct roads, parking lots, driveways, etc.

### BACKGROUND

Without limiting the scope of the invention, its background is described in connection with materials and methods for producing paving blocks. More particularly, the invention describes mixtures and methods for using thereof to mold various paving blocks.

Up to 11 million tons of post-consumer asphalt, shingle waste is generated annually in North America. A portion of this is processed into RAS (recycled asphalt shingle, which is a powder-like substance resulting from decontamination and grinding of shingles) and diverted successfully into use as a dust suppressant on gravel roads and parking lots, and as an additive in hot mix asphalt. But these uses have significant limitations (low value in the case of dust suppressant, and road specifications issues in the case of hot mix asphalt), and much of the post-consumer asphalt shingle waste ends up being land-filled. An alternative market as a material for use in forming paving blocks could raise the value of RAS and lead toward greater diversion of post-consumer asphalt shingle waste from landfills.

A close analog of RAS is RAP (recycled asphalt pavement, which is a gravel-like substance resulting from the milling of road surfaces or the crushing of broken asphalt pavement). Like RAS, RAP is used as an additive in hot mix asphalt, and in fact, is used much more extensively than RAS there. The proportion of RAP that is not used in hot mix asphalt has a lower value use as a gravel substitute, and so waste asphalt pavement is seldom land-filled. However, an alternative market as a material for use in forming paving blocks could raise the value of RAP and lead to a greater proportion of it being used in a higher value use than as a gravel substitute.

Asphalt cement (a form of bitumen) is present in both RAS and RAP. It is the binder still present in both materials. RAS typically has a range of 18-24% asphalt cement, whereas RAP has a much lower asphalt cement content, in the range of 5-6%. Asphalt cement is normally the most expensive material in the manufacture of roofing materials or hot mix asphalt, even at the low percentage of 5-6%, and so a recycling use that is able to harness the binder quality of post-consumer asphalt cement may be optimal with relation to material value.

The prior art fails to disclose the use of RAS and RAP, along with heat and pressure, as a basis for producing paving blocks. The need exists, therefore, for an improved method and improved components to be used for producing more durable paving blocks.

### SUMMARY

Accordingly, it is an object of the present invention to overcome these and other drawbacks of the prior art by providing a novel mixture for producing paving blocks.

It is another object of the present invention to provide a novel method of forming paving blocks using the mixture of the invention.

It is a further object of the present invention to provide methods of increasing the use of recycled materials in preparing paving blocks.

The present invention provides a mixture for producing paving products comprising recycled asphalt shingles (RAS) and recycled asphalt pavement (RAP) particles. The use of these components to form a resulting composite material provides a material that has considerable strength and durability, and absorbs a minimal amount of water, therefore making it nearly impervious to damage caused by the freeze/thaw cycle.

Further, the present invention provides a molded paving block using a mixture for producing paving products comprising RAP and RAS particles that are to be used to construct roads, parking lots, driveways, floors, and the like. The molded paving blocks of the present invention are to be used substantially in the same manner as presently available interlocking blocks.

The materials used are preferably recycled materials such as RAS and RAP. However, aggregate, whether virgin aggregate or recycled rock-like materials such as crushed glass, crushed concrete, crushed rubble, crushed seashells, et cetera, may be substituted or partially substituted for the RAP. There are many advantages to using recycled materials, such as the reduction of waste and lower cost of raw materials.

The preferred proportional amounts of materials in the composite material include RAP in a proportion of about 35% by mass, RAS in a proportion of about 30% by mass, rock-like material that is not RAP in a proportion of about 25% by mass, and hard surfacing material in a proportion of about 10% by mass.

The RAP should generally be the main or prevalent constituent of the composite material that forms the composite block of the present invention. However, the RAS, although generally a secondary constituent of the composite material, is of equal importance to the RAP because it contains a much higher percentage of the binder, asphalt cement, than does the RAP. The RAP (and other aggregates) provides the compressive strength and abrasion resistance of the composite material, whereas the RAS provides most of its cleavage strength and resistance to water absorption. The two together make a far superior paver than could be made with either alone.

Further, the present invention provides a process for manufacturing molded paving blocks, comprising the steps of heating and molding RAS and RAP into a molded paving block.

In one embodiment of the invention, the RAS and RAP are placed into a pugmill to be blended into a composite material; this composite material is molded in a press into a preform, and the preform is then heated in a conveyor oven to about 400 degrees F. and afterward, the heated preform is molded into a molded paving block in a second press.

In another embodiment of the invention, the RAS and RAP are placed into a pugmill to be blended into a composite material, and the composite material is conveyed in a heated auger that heats the composite material to about 400 degrees F. and deposits the heated composite material into a press where it is molded into a molded paving block.

In another embodiment of the invention, the RAS and RAP are molded in a press heated to about 400 degrees F. into a molded paving block.

In yet another embodiment of the invention, the RAS and RAP are molded in a press into a preform, the preform is heated in a conveyor oven to about 400 degrees F., and then the heated preform is molded into a molded paving block in a second press.

### BRIEF DESCRIPTION OF THE DRAWINGS

Subject matter is particularly pointed out and distinctly claimed in the concluding portion of the specification. The foregoing and other features of the present disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through the use of the accompanying drawings, in which:

FIG. 1 is a schematic diagram of a first process used to produce the molded paving block of the present invention;

FIG. 2 is a schematic diagram of a second process used to produce the molded paving block of the present invention;

FIG. 3 is a schematic diagram of a third process used to produce the molded paving block of the present invention; and

FIG. 4 is a schematic diagram of a fourth process used to produce the molded paving block of the present invention.

### DETAILED DESCRIPTION OF PREFERRED EMBODIMENTS OF THE INVENTION

The following description sets forth various examples along with specific details to provide a thorough understanding of claimed subject matter. It will be understood by those skilled in the art, however, that claimed subject matter may be practiced without one or more of the specific details disclosed herein. Further, in some circumstances, well-known methods, procedures, systems, components and/or circuits have not been described in detail in order to avoid unnecessarily obscuring claimed subject matter. In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the figures, can be arranged, substituted, combined, and designed in a wide variety of different configurations, all of which are explicitly contemplated and make part of this disclosure.

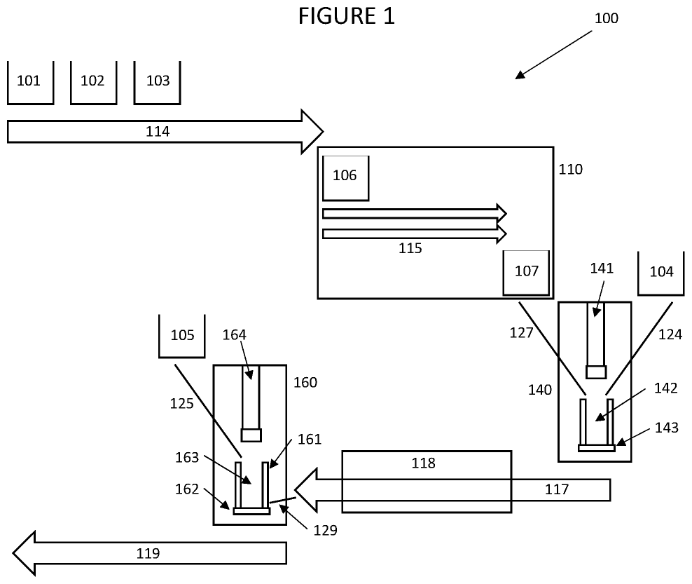

Reference will now be made to FIG. 1, which provides a schematic representation of a first process used to form the composite paving block of the present invention. At the start of production line 100, there are three metered load hoppers, 101, 102 and 103. The hopper 101 being for RAS, 102 for RAP, and 103 for rock-like material that is not RAP. The RAS, RAP, and rock-like material that is not RAP are loaded into their respective hoppers with a machine such as a front-end loader or a skid steer. The RAS, RAP, and rock-like material that is not RAP are metered proportionally by mass from hoppers 101, 102, and 103 onto conveyor 114 below the hoppers. Conveyor 114 conveys the RAS, RAP, and rock-like material that is not RAP to pug mill 110. Conveyor 114 deposits the RAS, RAP, and rock-like material that is not RAP into pug mill infeed hopper 106, through which the RAS, RAP, and rock-like material that is not RAP pass to pug mill mix augers 115. Pug mill mix augers 115 blend the RAS, RAP, and rock-like material that is not RAP together into the composite material, which is then discharged through pug mill metered discharge hopper 107. There is a fourth metered load hopper 104, which is for the hard surface material. Metered load hopper 104 is loaded with a machine such as a front-end loader or a skid steer, and it discharges through chute 124 directly into preform press 140. If hard surface material is being used, then preform press mold 142 is loaded first with the hard surface material, which is metered proportionally by mass from hopper 104 onto chute 124 and from there slides into preform press mold 142; but if hard surface material is not being used then this step is skipped. The composite material is metered proportionally by mass from hopper 107 onto chute 127 and, from there, slides into preform press mold 142 of preform press 140. Preform press ram 141 applies pressure to the material in preform press mold 142 to effect compaction of the material into a preform. Preform press ram 141 is then raised to remove pressure on the preform, and preform press floor 143 is moved out of the way by the actuator to allow preform press ram 141 to press the preform down onto conveyor 117 below. Conveyor 117 conveys the preform through continuous feed oven 118, where it is heated to about 400 degrees F. and then deposits the heated preform onto chute 129. The heated preform slides down chute 129 into mold press 160. Mold press side door 161 is opened by the actuator to allow the heated preform to enter mold press mold 163. Mold press side door 161 is closed by the actuator and mold press ram 164 applies pressure to the heated preform in mold press mold 163 to effect compaction of the heated preform into a molded paving block. Mold press ram 164 is then raised to remove pressure on the molded paving block, and mold press floor 162 is moved out of the way by the actuator to allow mold press ram 164 to press the molded paving block down onto conveyor 119 below. Conveyor 119 conveys the molded paving block some distance for cooling.

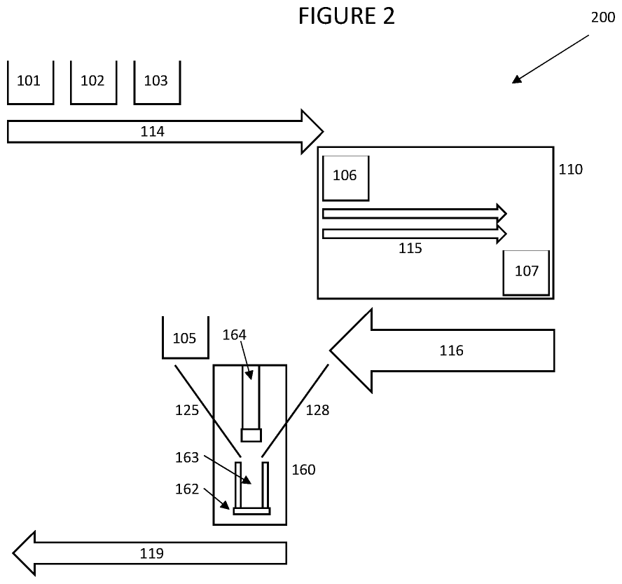

Reference will now be made to FIG. 2, which provides a schematic representation of a second process used to form the composite paving block of the present invention. At the start of production line 200, there are three metered load hoppers, 101, 102, and 103. The hopper 101 is for RAS, 102 for RAP, and 103 for rock-like material that is not RAP. The RAS, RAP, and rock-like material that is not RAP are loaded into their respective hoppers with a machine such as a front-end loader or a skid steer. The RAS, RAP, and rock-like material that is not RAP are metered proportionally by mass from hoppers 101, 102, and 103 onto conveyor 114 below the hoppers. Conveyor 114 conveys the RAS, RAP, and rock-like material that is not RAP to pug mill 110. Conveyor 114 deposits the RAS, RAP, and rock-like material that is not RAP into pug mill infeed hopper 106, through which the RAS, RAP, and rock-like material that is not RAP pass to pug mill mix augers 115. Pug mill mix augers 115 blend the RAS, RAP, and rock-like material that is not RAP together into the composite material, which is then discharged through pug mill metered discharge hopper 107. The composite material is metered proportionally by mass from hopper 107 into heated auger 116 below. Heated auger 116 heats the composite material to about 400 degrees F. as it draws it toward chute 128. There is a fourth metered load hopper 105, which is for the hard surface material. Metered load hopper 105 is loaded with a machine such as a front-end loader or a skid steer. If hard surface material is being used, then mold press mold 163 is loaded first with the hard surface material, which is metered proportionally by mass from hopper 105 onto chute 125 and from there slides into mold press mold 163; but if hard surface material is not being used then this step is skipped. Heated auger 116 deposits the heated composite material onto chute 128, and the heated composite material slides down chute 128 into mold press 160. Mold press ram 164 applies pressure to the material in mold press mold 163 to effect the compaction of the material into a molded paving block. Mold press ram 164 is then raised to remove pressure on the molded paving block, and mold press floor 162 is moved out of the way by the actuator to allow mold press ram 164 to press the molded paving block down onto conveyor 119 below. Conveyor 119 conveys the molded paving block some distance for cooling.

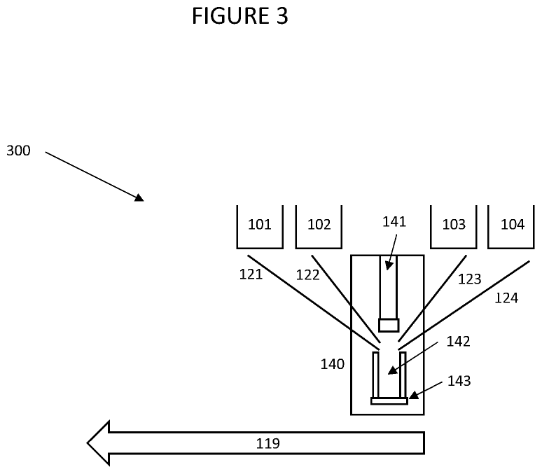

Reference will now be made to FIG. 3, which provides a schematic representation of a third and preferred process used to form the composite paving block of the present invention. At the start of production line 300, there are four temperature-controlled metered load hoppers, 101, 102, 103, and 104, with the hopper 101 being for RAS, 102 for RAP, 103 for rock-like material that is not RAP and 104 for hard surface material. The four materials are loaded into their respective hoppers with a machine such as a front-end loader or a skid steer. The four hoppers are heated with temperature control to maintain temperatures around the following for each of the four materials: RAS 100 F; RAP 140 F; rock-like material that is not RAP 1200 F; and hard surface material 450 F. Press 140 is heated with temperature control to maintain its temperature around 400 F. The materials are metered proportionally by mass from their hoppers via a chute into press mold 142. If hard surface material is being used, then press mold 142 is loaded first with the hard surface material, which is metered proportionally by mass from hopper 104 onto chute 124 and from there slides into press mold 142; but if hard surface material is not being used then this step is skipped. The RAS, RAP, and rock-like material that is not RAP are metered proportionally by mass from hoppers 101, 102 and 103, respectively, onto chutes 121, 122, and 123, respectively, and from there slide into press mold 142 of press 140. The RAS, RAP, and rock-like material that is not RAP are loaded intermittently so that many layers of RAS are interspersed with many layers of RAP and many layers of rock-like material that is not RAP until press mold 142 is filled to the desired level. The mixture of materials with varying temperatures results in a blended temperature of around 400 F. Press ram 141 applies pressure to the material in press mold 142 to effect the compaction of the material into a molded paving block. Press ram 141 is then raised to remove pressure on the molded paving block, and press floor 143 is moved out of the way by the actuator to allow press ram 141 to press the molded paving block down onto conveyor 119 below. Conveyor 119 conveys the molded paving block some distance for cooling.

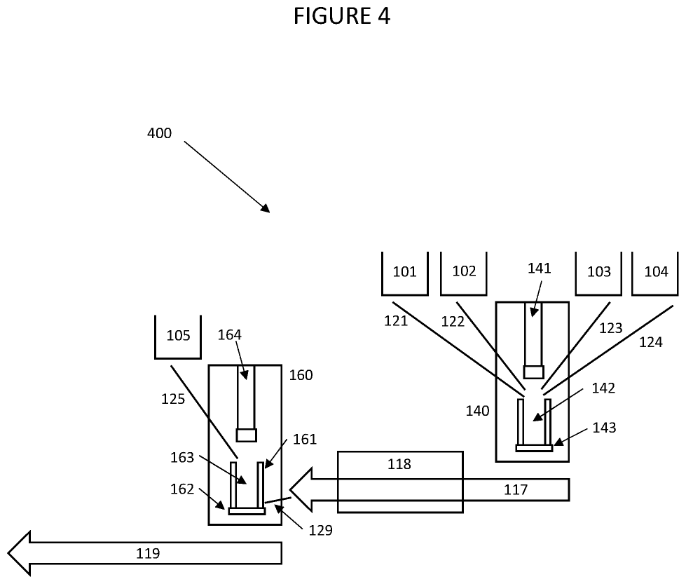

Reference will now be made to FIG. 4, which provides a schematic representation of a fourth process used to form the composite paving block of the present invention. At the start of production line 400, there are four metered load hoppers, 101, 102, 103, and 104, with hopper 101 being for RAS, 102 for RAP, 103 for rock-like material that is not RAP, and 104 for hard surface material. The four materials are loaded into their respective hoppers with a machine such as a front-end loader or a skid steer. The materials are metered proportionally by mass from their hoppers via a chute into preform press mold 142. If hard surface material is being used, then preform press mold 142 is loaded first with the hard surface material, which is metered proportionally by mass from hopper 104 onto chute 124 and from there slides into preform press mold 142; but if hard surface material is not being used then this step is skipped. The RAS, RAP, and rock-like material that is not RAP are metered proportionally by mass from hoppers 101, 102 and 103, respectively, onto chutes 121, 122, and 123, respectively, and from there slide into preform press mold 142 of preform press 140. The RAS, RAP, and rock-like material that is not RAP are loaded intermittently so that many layers of RAS are interspersed with many layers of RAP and many layers of rock-like material that is not RAP until the preform press mold is filled to the desired level. Preform press ram 141 applies pressure to the material in preform press mold 142 to effect compaction of the material into a preform. Preform press ram 141 is then raised to remove pressure on the preform, and preform press floor 143 is moved out of the way by the actuator to allow preform press ram 141 to press the preform down onto conveyor 117 below. Conveyor 117 conveys the preform through continuous feed oven 118, where it is heated to about 400 degrees F. and then deposits the heated preform onto chute 129. Mold press side door 161 is opened by the actuator to allow the heated preform to enter mold press mold 163. The heated preform slides down chute 129 into mold press 160. Mold press side door 161 is closed by the actuator, and mold press ram 164 applies pressure to the heated preform in mold press mold 163 to effect compaction of the heated preform into a molded paving block. Mold press ram 164 is then raised to remove pressure on the molded paving block, and mold press floor 162 is moved out of the way by the actuator to allow mold press ram 164 to press the molded paving block down onto conveyor 119 below. Conveyor 119 conveys the molded paving block some distance for cooling.

With regard to all of the processes shown, although the drawings show only a single compartment in the molding systems depicted, all of the molding systems may comprise a single compartment or multiple compartments; and likewise with the support apparatus for each molding system.

With regard to certain of the processes shown, there are various ways of loading the heated preform from the continuous feed oven into the mold press, including, among others, manual loading, loading via the robotic arm, and loading via mechanically guided dropping. Mold press side door 161 and chute 129 are shown for simplicity.

With regard to certain of the processes shown, the heated preform should be appreciably shorter and thinner than mold press mold 163 so as to ease loading into mold press mold 163.

With regard to all processes shown, it is possible to preheat the RAS and RAP prior to depositing them into hoppers 101 and 102, respectively. Working with the RAS while it is below the temperature of 100 F. and RAP while it is below the temperature of 140 F. is advantageous for two reasons. The first reason is that these materials do not adhere badly to the equipment when they are below these temperatures, whereas they do adhere once they are warmed above these temperatures. Such adherence causes ongoing maintenance issues with the equipment, including the need for frequent cleaning and the need to shutdown to clear out components to avoid the risk of them requiring intensive de-gumming. The other reason is that heating RAS and RAP releases volatile organic compounds from any heated surface area. The release of these volatile organic compounds causes noxious odors that must be controlled and also reduces the binder quality of the asphalt cement in the RAS and RAP. So keeping the RAS and RAP below these threshold temperatures prior to the molding of the preform, at which point the surface area of the RAS and RAP is minimized to the surface area of the preform, is far better than heating the RAS and RAP appreciably prior to molding the preform.

With regard to certain of the processes shown, although a pug mill is shown as the blending device, there are many other adequate types of blending devices that can be used instead of a pug mill.

With regard to all processes shown, the RAS, RAP, and rock-like material that is not RAP have preferably been screened such that all pieces are of a size under 1″ in any dimension.

With regard to all processes shown, the hard surface material has preferably been screened such that all pieces are of a size under ⅜″ in any dimension.

With regard to all processes shown, it has been found that a temperature of about 250 degrees F. to about 425 degrees F., and particularly a temperature of about 350 degrees F. to about 400 degrees F., is useful in providing the proper heat for producing a molded paving block with the desired level of compressive strength and resistance to water absorption.

With regard to all processes shown, the proportional mix of RAS and RAP is important. The RAP (or rock-like material that is not RAP) provides the compressive strength and abrasion resistance of the composite material, whereas the RAS provides most of its cleavage strength and resistance to water absorption. The two together make a far superior paver than could be made with either alone. However, in an instance where the objective is to use as much RAS as possible, the proportion of RAP can be reduced. Although such RAP reduction could be taken even to the point of elimination, the loss of compressive strength becomes significant enough that the molded paving blocks produced would be unsuitable for anything other than walking paths. If the RAS component exceeds 50% then the compressive strength is essentially provided by the binder, and the aggregate is superfluous.

With regard to all processes shown, although rock-like material that is not RAP can replace RAP entirely, there is good reason to use some portion of RAP. This is because RAP is already coated with asphalt cement, whereas rock-like material that is not RAP is not coated with asphalt cement; this results in the RAS binding more easily with RAP than with rock-like material that is not RAP. When rock-like material that is not RAP is used, the asphalt cement in the RAS is absorbed to a greater degree into the rock-like material that is not RAP, thus requiring one or more of a higher percentage of RAS, higher pressure, or more dwell time in the oven.

It is contemplated that any embodiment discussed in this specification can be implemented with respect to any method of the invention, and vice versa. It will be also understood that particular embodiments described herein are shown by way of illustration and not as limitations of the invention. The principal features of this invention can be employed in various embodiments without departing from the scope of the invention. Those skilled in the art will recognize, or be able to ascertain using no more than routine experimentation, numerous equivalents to the specific procedures described herein. Such equivalents are considered to be within the scope of this invention and are covered by the claims.

All publications and patent applications mentioned in the specification are indicative of the level of skill of those skilled in the art to which this invention pertains. All publications and patent applications are herein incorporated by reference to the same extent as if each individual publication or patent application was specifically and individually indicated to be incorporated by reference. Incorporation by reference is limited such that no subject matter is incorporated that is contrary to the explicit disclosure herein, no claims included in the documents are incorporated by reference herein, and any definitions provided in the documents are not incorporated by reference herein unless expressly included herein.

The use of the word “a” or “an” when used in conjunction with the term “comprising” in the claims and/or the specification may mean “one,” but it is also consistent with the meaning of “one or more,” “at least one,” and “one or more than one.” The use of the term “or” in the claims is used to mean “and/or” unless explicitly indicated to refer to alternatives only or the alternatives are mutually exclusive, although the disclosure supports a definition that refers to only alternatives and “and/or.” Throughout this application, the term “about” is used to indicate that a value includes the inherent variation of error for the device, the method being employed to determine the value, or the variation that exists among the study subjects.

As used in this specification and claim(s), the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps. In embodiments of any of the compositions and methods provided herein, “comprising” may be replaced with “consisting essentially of” or “consisting of”. As used herein, the phrase “consisting essentially of” requires the specified integer(s) or steps as well as those that do not materially affect the character or function of the claimed invention. As used herein, the term “consisting” is used to indicate the presence of the recited integer (e.g., a feature, an element, a characteristic, a property, a method/process step or a limitation) or group of integers (e.g., feature(s), element(s), characteristic(s), propertie(s), method/process steps or limitation(s)) only.

The term “or combinations thereof” as used herein refers to all permutations and combinations of the listed items preceding the term. For example, “A, B, C, or combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, AB, BBC, AAABCCCC, CBBAAA, CABABB, and so forth. The skilled artisan will understand that typically there is no limit on the number of items or terms in any combination, unless otherwise apparent from the context.

As used herein, words of approximation such as, without limitation, “about”, “substantial” or “substantially” refers to a condition that when so modified is understood to not necessarily be absolute or perfect but would be considered close enough to those of ordinary skill in the art to warrant designating the condition as being present. The extent to which the description may vary will depend on how great a change can be instituted and still have one of ordinary skilled in the art recognize the modified feature as still having the required characteristics and capabilities of the unmodified feature. In general, but subject to the preceding discussion, a numerical value herein that is modified by a word of approximation such as “about” may vary from the stated value by at least ±1, 2, 3, 4, 5, 6, 7, 10, 12, 15, 20 or 25%.

All of the devices and/or methods disclosed and claimed herein can be made and executed without undue experimentation in light of the present disclosure. While the devices and methods of this invention have been described in terms of preferred embodiments, it will be apparent to those of skill in the art that variations may be applied to the devices and/or methods and in the steps or in the sequence of steps of the method described herein without departing from the concept, spirit and scope of the invention. All such similar substitutes and modifications apparent to those skilled in the art are deemed to be within the spirit, scope and concept of the invention as defined by the appended claims.

What is claimed is:

1. A mixture for producing paving products comprising recycled asphalt pavement particles in the amount of 20 to 80 percent of the mixture by weight, and recycled asphalt shingle particles.

2. The mixture for producing paving products as in claim 1, wherein the amount of recycled asphalt shingle particles is from 5 to 80 percent of the mixture by weight.

3. The mixture for producing paving products as in claim 1, wherein the amount of recycled asphalt shingle particles is from 10 to 40 percent of the mixture by weight.

4. The mixture for producing paving products as in claim 1, further comprising a rock-like material that is not recycled asphalt pavement.

5. The mixture for producing paving products as in claim 4, wherein the amount of rock-like material that is not recycled asphalt pavement is from 10 to 50 percent of the mixture by weight.

6. The mixture for producing paving products as in claim 4, wherein the rock-like material that is not recycled asphalt pavement is selected from a group consisting of virgin rock such as sand and gravel or recycled rock-like materials such as crushed glass, crushed concrete, crushed rubble, crushed seashells et cetera.

7. The mixture for producing paving products as in claim 4, further comprising a hard surfacing material.

8. The mixture for producing paving products as in claim 7, wherein the amount of hard surfacing material is from 2 to 15 percent of the mixture by weight.

9. The mixture for producing paving products as in claim 7, wherein the hard surfacing material is selected from a group consisting of rocks, pieces of metal, synthetic rocks, or a mix thereof.

10. The mixture for producing paving products as in claim 7, containing at least 20 percent by weight of the recycled asphalt shingle particles, at least 25 percent by weight of the recycled asphalt pavement particles, at least 15 percent by weight of the rock-like material that is not recycled asphalt pavement, and at least 2 percent by weight of the hard surfacing material.

11. The mixture for producing paving products as in claim 7, wherein no recycled asphalt pavement particle or recycled asphalt shingle particle or rock-like material particle that is not recycled asphalt pavement is larger than 1 inch, and no hard surfacing material particle is larger than ⅜ of an inch.

12. A paving block produced using the mixture for producing paving products as in claim 1.

13. The paving block as in claim 1 characterized by being able to withstand a compressive force of at least 2,000 pounds per square inch and allowing no more than 4% water absorption.

14. A method of manufacturing a paving block using a mixture for producing paving products as in claim 1, the method comprising the following steps:
(a) mixing recycled asphalt shingle particles and recycled asphalt pavement particles to produce a homogenous mixture thereof,
(b) positioning the mixture of step (a) into a primary molding system configured to produce a self-supporting preform,
(c) applying a first pressure using the primary molding system to mold the mixture contained therein into a self-supporting preform,
(d) heating up the self-supporting preform to a temperature from 200 degrees F. to 425 degrees F.,
(e) transferring the self-supporting preform to a secondary molding system, and
(f) applying a second pressure using the secondary molding system to mold the self-supporting preform into a paving block.

15. The method as in claim 14, wherein the first pressure is at or above 2,000 pounds per square inch.

16. The method as in claim 14, wherein the second pressure is at or above 2,000 pounds per square inch.

17. The method as in claim 14, wherein step (d) is accomplished using a continuous feed oven with a traveling belt.

18. The method as in claim 14, further comprising a step of mixing rock-like material that is not recycled asphalt pavement in with the recycled asphalt shingle particles and recycled asphalt pavement particles to produce a homogenous mixture in step (a).

19. The method as in claim 14, further comprising a step of positioning a hard surfacing material into the primary molding system prior to performing step (b).

20. The method as in claim 14, further comprising a step of positioning a hard surfacing material into the secondary molding system prior to performing step (e).

21. A method of manufacturing paving blocks using a mixture for producing paving products as in claim 1, the method comprising the following steps:
(a) mixing recycled asphalt shingle particles and recycled asphalt pavement particles to produce a homogenous mixture thereof,
(b) heating the homogenous mixture of step (a) while continuing to mix the components thereof to a temperature from 200 degrees F. to 425 degrees F.,
(c) distributing the heated mixture into compartments of a molding system, and
(d) applying pressure using the molding system to form the paving blocks.

22. The method as in claim 21, wherein the pressure in step (d) is at or above 2,000 pounds per square inch.

23. The method as in claim 21, further comprising a step of mixing rock-like material that is not recycled asphalt pavement in with the recycled asphalt shingle particles and recycled asphalt pavement particles to produce a homogenous mixture in step (a).

24. The method as in claim 21, further comprising a step of placing hard surfacing material into the compartments of the molding system prior to step (c).

25. A method of manufacturing paving blocks using a mixture of claim 1, the method comprising the following steps:
(a) filling compartments of a molding system with recycled asphalt shingle particles and recycled asphalt pavement particles of claim 1 in a manner that causes a homogenous mixture thereof to be formed in each compartment thereof,
(b) heating the molding system to a temperature from 200 degrees F. to 425 degrees F., and
(c) applying pressure using the molding system to form the paving blocks.

26. The method as in claim 25, wherein the pressure in step (c) is at or above 2,000 pounds per square inch.

27. The method as in claim 25, further comprising a step of filling compartments of a molding system with recycled asphalt shingle particles and recycled asphalt pavement particles of claim 1 and rock-like material that is not recycled asphalt pavement in a manner that causes a homogenous mixture thereof to be formed in each compartment thereof in step (a).

28. The method as in claim 25, further comprising a step of placing hard surfacing material into the compartments of the molding system prior to step (a).

29. A method of manufacturing paving blocks using a mixture of claim 1, the method comprising the following steps:
(a) filling compartments of a primary molding system with recycled asphalt shingle particles and recycled asphalt pavement particles of claim 1 in a manner that causes a homogenous mixture thereof to be formed in each compartment thereof,
(b) compressing the primary molding system to produce self-supporting preforms,
(c) heating up the self-supporting preforms to a temperature from 200 degrees F. to 425 degrees F.,
(d) transferring the self-supporting preforms to a secondary molding system, and
(e) compressing the secondary molding system to form the self-supporting preforms into paving blocks.

30. The method as in claim 29, wherein the pressure in step (b) is at or above 2,000 pounds per square inch.

31. The method as in claim 29, wherein the pressure in step (e) is at or above 2,000 pounds per square inch.

32. The method as in claim 29, further comprising a step of filling compartments of a primary molding system with recycled asphalt shingle particles and recycled asphalt pavement particles of claim 1 and rock-like material that is not recycled asphalt pavement in a manner that causes a homogenous mixture thereof to be formed in each compartment thereof in step (a).

33. The method as in claim 29, further comprising a step of placing hard surfacing material into the compartments of the primary molding system prior to step (a).

34. The method as in claim 29, further comprising a step of placing hard surfacing material into the compartments of the secondary molding system prior to step (d).

35. The method as in claim 29, wherein step (c) is accomplished using a continuous feed oven with a traveling belt.
